(19) United States
(12) Patent Application Publication
(10) Pub. No.: US 2007/0126497 A1
(43) Pub. Date: Jun. 7, 2007

(54) Method and apparatus for programming one or more programmable components of a bootstrap circuit

(76) Inventors: Sithambaram Palaniappan, Sungai Petani Kedah (MY); Ewe Aik Oo, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/292,964

(22) Filed: Dec. 1, 2005

(51) Int. Cl. H02M 3/07

(52) U.S. Cl. 327/589

(57) ABSTRACT

In one embodiment, an indication of a frequency of a PWM input signal is received, with the PWM input signal being generated for the purpose of controlling a drive circuit. In response to the indication of the frequency of the PWM input signal, one or more outputs for programming one or more programmable components of a bootstrap circuit are automatically and electronically generated. The bootstrap circuit provides a supply voltage for the drive circuit. In another embodiment, apparatus is provided with a bootstrap programming circuit to, in response to an indication of a frequency of a PWM input signal, the PWM input signal being generated for the purpose of controlling a drive circuit, generate one or more outputs for programming one or more programmable components of a bootstrap circuit that provides a supply voltage for the drive circuit.

### BACKGROUND

In motor drive topologies, a motor drive signal may be formed by alternately coupling high-side and low-side drive circuits to an output node. Each of the drive circuits will typically comprise a transistor switch; and, upon application of a pulse-width modulated (PWM) drive signal to the gate of one of the transistor switches, its respective drive circuit will be alternately coupled and decoupled to the motor drive's output node.

In the above-described topology, a problem encountered with the high-side drive circuit is that its gate potential must constantly float above its drain potential to maintain the “ON” state of its transistor switch.

To mitigate the chances that the PWM drive signal will prematurely decay, the supply voltage to the high-side gate drive may be provided by means of a “bootstrap circuit”. The bootstrap circuit comprises, in part, a bootstrap capacitor that 1) is charged when the high-side drive circuit is decoupled from the motor drive's output node (i.e., when the low-side drive circuit is coupled to the motor drive's output node), and 2) supplies the high-side drive circuit with a constant shifted voltage above the drain potential when the high-side circuit is coupled to the output node. If the bootstrap capacitor and other components of the bootstrap circuit are properly sized, the intended duty cycle of the PWM drive signal may be maintained.

### SUMMARY OF THE INVENTION

In one embodiment, a method comprises 1) receiving an indication of a frequency of a PWM input signal, the PWM input signal being generated for the purpose of controlling a drive circuit; and 2) in response to the indication of the frequency of the PWM input signal, automatically and electronically generating one or more outputs for programming one or more programmable components of a bootstrap circuit that provides a supply voltage for the drive circuit.

In another embodiment, apparatus comprises a bootstrap programming circuit to, in response to an indication of a frequency of a PWM input signal, the PWM input signal being generated for the purpose of controlling a drive circuit, generate one or more outputs for programming one or more programmable components of a bootstrap circuit that provides a supply voltage for the drive circuit.

Other embodiments are also disclosed.

### BRIEF DESCRIPTION OF THE DRAWINGS

Illustrative embodiments of the invention are illustrated in the drawings, in which:

FIG. 1 illustrates an exemplary drive circuit in which a bootstrap circuit is used to provide a supply voltage for generating a PWM gate drive signal;

FIG. 2 illustrates the decay and charge of the voltage across the bootstrap capacitor of the FIG. 1 apparatus;

FIG. 3 illustrates the use of a pulse at the low-side drive circuit of the FIG. 1 apparatus, for the purpose of charging the bootstrap capacitor of the FIG. 1 apparatus;

FIG. 4 illustrates an under-voltage situation that might require a pulse at the low-side drive circuit of the FIG. 1 apparatus, as shown in FIG. 3;

FIG. 5 illustrates an exemplary method for programming a bootstrap circuit such as the bootstrap circuit of the FIG. 1 drive circuit;

FIG. 6 illustrates exemplary apparatus for implementing the method shown in FIG. 5.

### DETAILED DESCRIPTION

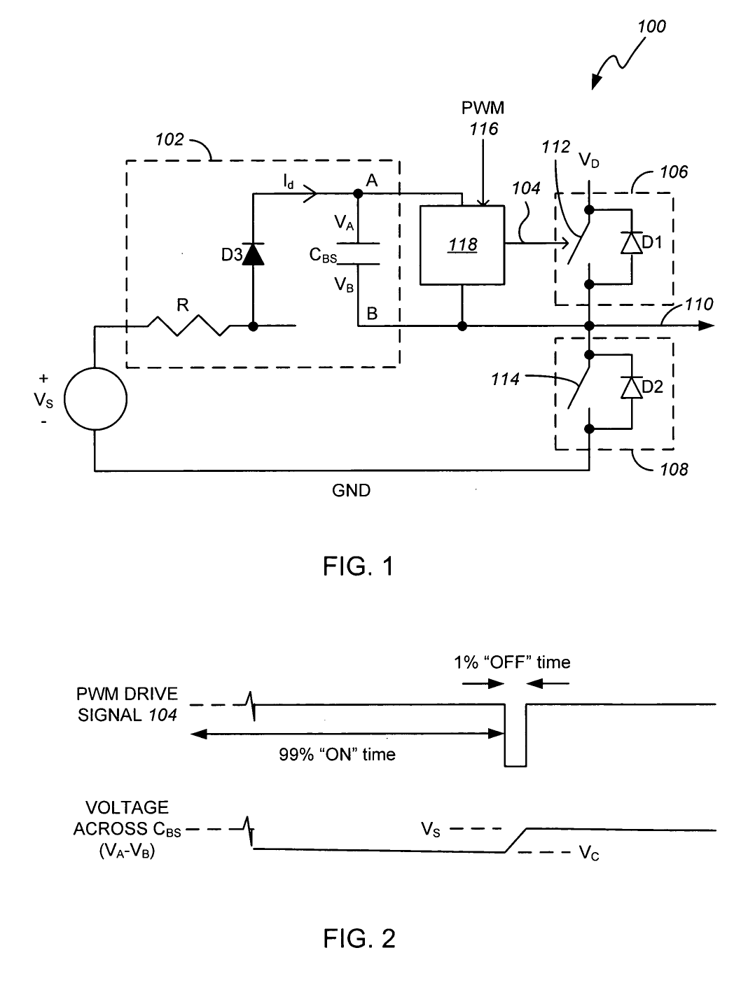

FIG. 1 illustrates an exemplary drive circuit 100 in which a bootstrap circuit 102 is used to provide a supply voltage for generating a PWM gate drive signal 104.

By way of example, the drive circuit 100 comprises high-side and low-side drive circuits 106, 108, both of which are coupled to an output node 110. The high-side drive circuit 106 is coupled between a voltage source V_{D} and the output node 110. The low-side drive circuit 108 is coupled between the output node 110 and ground. Each of the drive circuits 106, 108 comprise a transistor switch 112 or 114 that is coupled in parallel with a respective diode D1 or D2 in a half-bridge drive configuration. By alternately coupling the high-side and low-side drive circuits 106, 108 of two different pairs of the drive circuits to the output node 110, an output signal such as a motor drive signal may be formed at the output node 110.

The remainder of this disclosure will focus on methods and apparatus for controlling the transistor switch 112 of the high-side drive circuit 106.

Assuming that the switch 112 is a metal-oxide semiconductor field-effect transistor (MOSFET), the state of the switch 112 may be controlled by applying a PWM drive signal 104 to its gate. The PWM drive signal 104 is generated by a gate drive circuit 118. In some cases, the gate drive circuit 118 may comprise various protection circuits, such as an under-voltage protection circuit. The gate drive circuit 118 receives a PWM input signal 116, and in response thereto, generates the PWM gate drive signal 104.

Typically, the PWM input signal 116 will be a relatively low voltage, low current signal. The gate drive circuit 118 may therefore generate a high-voltage, high current PWM drive signal 104 in response to the PWM input signal 116. One way to do this is to amplify the PWM input signal 116 using an amplifier powered by a stable supply voltage, (V_{A}−V_{B}). The stable supply voltage may be provided by the bootstrap circuit 102.

As shown, the bootstrap circuit 102 may comprise a bootstrap resistor (R), a bootstrap capacitor (C_{BS}) and a diode (D₃). In use, a voltage source (Vₛ) charges the bootstrap capacitor (C_{BS}) by generating a current (I_{d}) through the bootstrap resistor (R). The diode (D₃) prevents leakage currents from flowing back toward the voltage source (Vₛ).

The objective of the bootstrap circuit 102 is to hold the voltage at node A at a voltage V_{S} above the voltage at node B, regardless of the duty cycle of the PWM input signal 116. This is accomplished by calculating optimum values for the bootstrap resistor (R) and bootstrap capacitor (C_{BS}), in light of worst-case high and low duty cycles of the PWM input signal 116 (e.g., for duty cycles from 1% to 99%). For the worst-case high duty cycle, which causes the switch 112 to be closed over 99% of the input signal's duty cycle, the voltage across the fully charged bootstrap capacitor (C_{BS}) will decline from a voltage V_{A}−V_{B}=V_{S} to a voltage V_{A}−V_{B}=V_{c}, as a result of the current, I_{G}, consumed by the switch 112. See FIG. 2.

By knowing the maximum turn-on time of the switch 112, the declination in voltage (V_{S}−V_{C}), and the current I_{d}, an optimum value for the bootstrap capacitor (C_{BS}) can be calculated. The critical parameter in the calculation is the maximum turn-on time of the switch 112, which is dynamic in the sense that it is subject to change with variations in the frequency (or period) of the PWM input signal 116. The other two parameters (declination in voltage and the current I_{d}) can be fixed to optimum values as per the drive requirements of the gate of the switch 112.

An optimum value for the bootstrap resistor (R) can be calculated such that the time constant (CR) of the bootstrap circuit 102 will enable the declination in voltage (V_{S}−V_{C}) to be replenished within the worst-case high duty cycle of the PWM input signal 116 (i.e., when the switch 112 is opened, or turned “OFF”, for only 1% of the input signal's duty cycle).

In some cases, the frequency of the PWM input signal 116 may be programmable; different drive circuits may be matched to different drive controllers; or different applications for a drive circuit may demand different PWM frequencies. In these and other cases, the optimum value of the time constant CR may need to be changed.

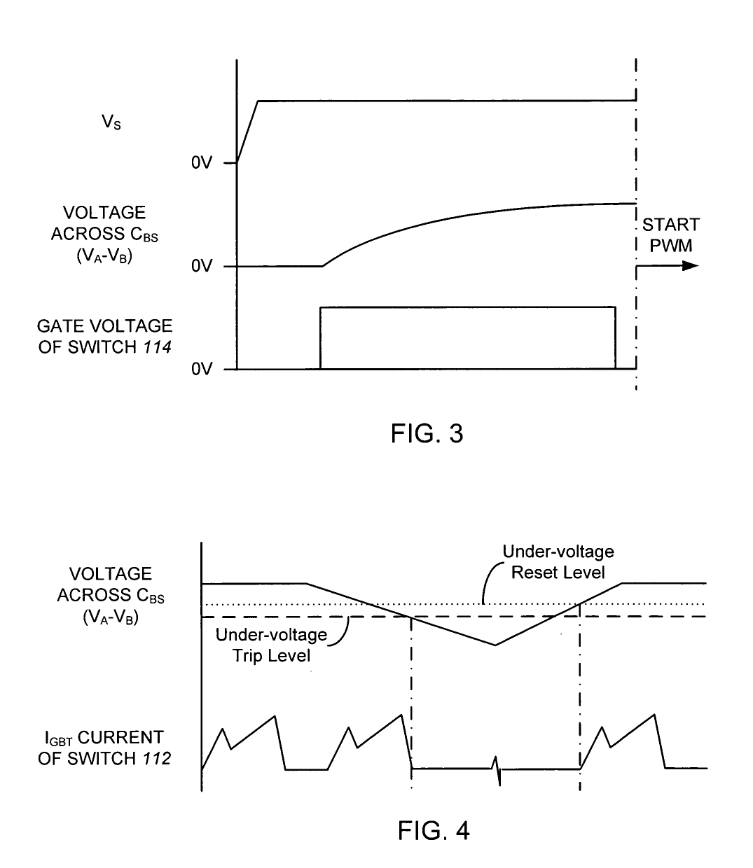

Before pulse-width modulation of the high-side drive circuit 106 can commence, a pulse first has to be generated at the gate of the switch 114 of the low-side drive circuit 108. The pulse at the low-side drive circuit 108 is necessary to place an initial charge on the bootstrap capacitor (C_{BS}). Hence, a longer than required CR time constant will increase the required length of the first pulse at the low-side drive circuit 108, and will therefore delay 1) the start of pulse-width modulation of the high-side drive circuit 106, and 2) the formation of the drive signal at node 110. See FIG. 3.

A startup pulse at the low-side drive circuit 108 may also be required in an under-voltage situation. That is, if the voltage across the capacitor CBS falls below a threshold, the previously mentioned under-voltage protection circuit may disable the gate drive circuit 118 until the voltage across the capacitor CBS is replenished. In these situations, a longer than required CR time constant will increase the required length of any startup pulse that is applied to the low-side drive circuit 108. See FIG. 4.

If the bootstrap resistor (R) and bootstrap capacitor (C_{BS}) are not optimized, the performance of the drive circuit 100 will suffer. However, in cases where the frequency of the PWM input signal 116 and other factors are subject to change, the optimum range of a particular resistor and capacitor combination may often be exceeded. In these cases, either 1) new values of the bootstrap resistor and capacitor need to be calculated, and the resistor and capacitor need to be replaced, or 2) the performance of the drive circuit 100 will suffer.

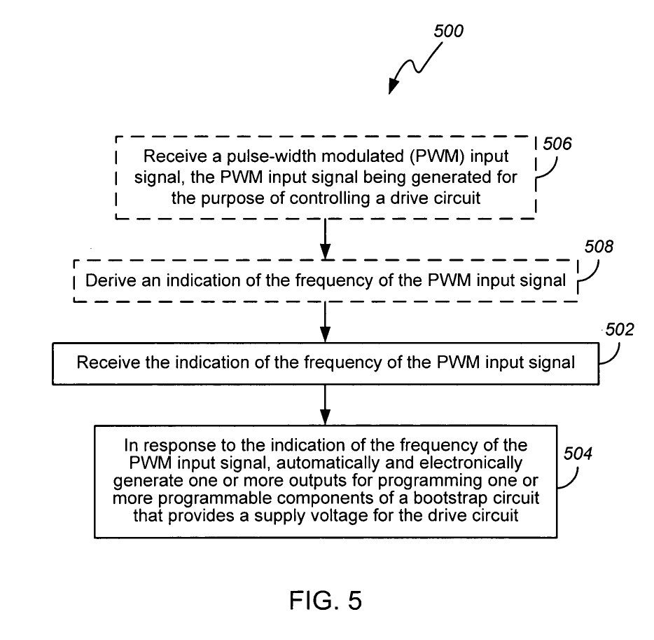

In light of the above need to optimize the values of the components of a bootstrap circuit, FIG. 5 illustrates an exemplary method 500 for programming a bootstrap circuit such as the circuit 102. The method 500 comprises 1) receiving 502 an indication of a frequency of a PWM input signal 116, the PWM input signal 116 being generated for the purpose of controlling a drive circuit 100; and 2) in response to the indication of the frequency of the PWM input signal 116, automatically and electronically generating 504 one or more outputs for programming one or more programmable components of the bootstrap circuit 102. Once programmed, the bootstrap circuit 102 provides an optimum supply voltage for the drive circuit 100, and does so with an optimum time constant.

Optionally, the method 100 may comprise receiving 506 the PWM input signal 116 and deriving 508 the indication of the frequency of the PWM input signal 116.

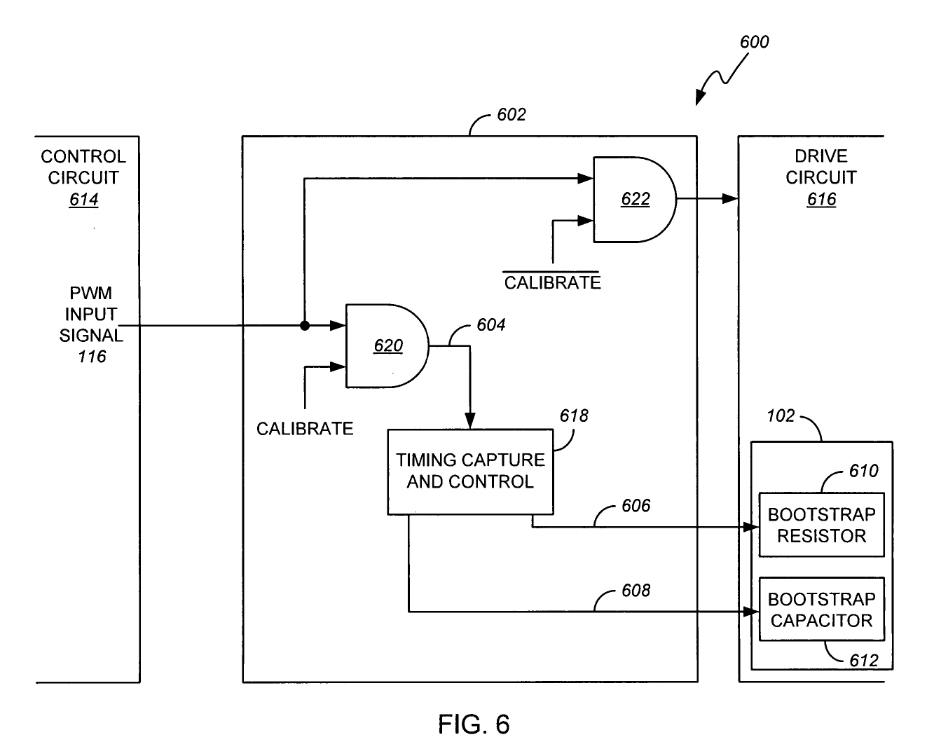

In one embodiment, the method 500 may be implemented using the apparatus 600 shown in FIG. 6. By way of example, the apparatus 600 comprises a bootstrap programming circuit 602 to, in response to the indication 604 of the frequency of the PWM input signal 116, generate the one or more outputs 606, 608 for programming the one or more programmable components 610, 612 of the bootstrap circuit 102. By way of example, the bootstrap programming circuit 602 may alternately be: a standalone circuit (as shown), integrated with the control circuit 614 (e.g., integrated with a motor controller), or integrated with the drive circuit 616 (e.g., integrated with a motor driver).

As shown in FIG. 6, the control circuit 614 generates the PWM input signal 116 and provides it to the bootstrap programming circuit 602. If the control circuit 614 is capable of directly generating the indication 604 of the frequency of the PWM input signal 116, then the bootstrap programming circuit 602 need only generate the appropriate outputs for programming one or more programmable components 610, 612 of the bootstrap circuit 102. This may be done, for example, via a microprocessor 618 that calculates the optimum values for the components 610, 612, or via a simple hard-coded look-up table that outputs programming signals corresponding to a “best match” for a particular frequency of the PWM input signal 116.

If the control circuit 614 is not capable of generating the indication 604 of the frequency of the PWM input signal 116, then the bootstrap programming circuit 602 needs to somehow determine the input signal's frequency. This may be done, for example, via a timing capture circuit (e.g., part of microprocessor 618) that uses the edges of the PWM input signal 116 to set interrupts that start and stop one or more timers for determining the period of the PWM input signal 116 (or the periods of both the high and low times of the PWM input signal 116). Once the period of the PWM input signal 116 is determined, it may serve as the indication 604 of the frequency of the PWM input signal 116 and can be used by the microprocessor 618 to generate the appropriate outputs for programming the one or more programmable components 610, 612 of the bootstrap circuit 102.

Preferably, the bootstrap programming circuit 602 generates outputs for programming both a bootstrap resistance value and a bootstrap capacitance value. However, if one or the other of these components has a fixed value, or if the bootstrap circuit 102 comprises additional or different components, the bootstrap programming circuit 602 could be programmed to generate more, fewer and/or different programming signals.

Although the outputs 606, 608 generated by the bootstrap programming circuit 602 may be analog or digital outputs, they are preferably digital outputs; and the resistor (R) and the capacitor (C_{BS}) of the bootstrap circuit 102 are preferably, and respectively, a digitally programmable resistor 610 and a digitally programmable capacitor 612.

In one embodiment, and as shown in FIG. 6, the apparatus 600 may comprise one or more logic gates 620, 622 to 1) direct the PWM input signal 116 to the timing capture circuit of the microprocessor 618 during a calibration mode of the apparatus 600, and 2) direct the PWM input signal 116 to the drive circuit 616 during an operating mode of the apparatus 600. When a calibration signal (CALIBRATE) is asserted, a first of the logic gates 620 may direct the PWM input signal 116 to the microprocessor 618, and a second of the logic gates 622 may prevent the PWM input signal 116 from being provided to the drive circuit 616. In this manner, the drive circuit 616 does not receive the PWM input signal 116 until the resistor (R) and capacitor (C_{BS}) of the bootstrap circuit 102 have been programmed.

After bootstrap programming is complete, the calibration signal (CALIBRATE) is de-asserted. At this time, the first of the logic gates 620 may prevent the microprocessor 618 from receiving the PWM input signal 116, and the second of the logic gates 622 may direct the PWM input signal 116 to the drive circuit 616. In one embodiment, the programming outputs 606, 608 of the microprocessor 618 may be preserved in a non-volatile memory, such as an EEPROM. In this manner, the outputs 606, 608 may be preserved through power-cycling and the like and do not have to be re-calculated until a user adjusts the frequency of the PWM input signal 116. In one embodiment, configuration changes such as a frequency change in the PWM input signal 116 may automatically cause the calibration signal (CALIBRATE) to be asserted.

What is claimed is:

1. Apparatus, comprising:
a bootstrap programming circuit to, in response to an indication of a frequency of a pulse-width modulated (PWM) input signal, the PWM input signal being generated for the purpose of controlling a drive circuit, generate one or more outputs for programming one or more programmable components of a bootstrap circuit that provides a supply voltage for the drive circuit.

2. The apparatus of claim 1, wherein one of the outputs generated by the bootstrap programming circuit is an output for programming a bootstrap resistance value.

3. The apparatus of claim 1, wherein one of the outputs generated by the bootstrap programming circuit is an output for programming a bootstrap capacitance value.

4. The apparatus of claim 1, wherein the outputs generated by the bootstrap programming circuit comprise outputs for programming a bootstrap resistance value and a bootstrap capacitance value.

5. The apparatus of claim 1, wherein the outputs of the bootstrap programming circuit are digital outputs.

6. The apparatus of claim 1, further comprising the bootstrap circuit, wherein:
the bootstrap circuit has a digitally programmable bootstrap resistor and a digitally programmable bootstrap capacitor; and
the outputs generated by the bootstrap programming circuit respectively program the digitally programmable bootstrap resistor and the digitally programmable bootstrap capacitor.

7. The apparatus of claim 1, further comprising a motor controller to generate the PWM input signal.

8. The apparatus of claim 1, further comprising a timing capture circuit to receive the PWM input signal and generate the indication of the frequency of the PWM input signal.

9. The apparatus of claim 8, further comprising at least one logic gate to i) direct the PWM input signal to the timing capture circuit during a calibration mode of the apparatus, and ii) direct the PWM input signal to the drive circuit during an operating mode of the apparatus.

10. The apparatus of claim 8, wherein the frequency of the PWM input signal is programmable.

11. The apparatus of claim 1, further comprising the drive circuit.

12. The apparatus of claim 11, wherein the drive circuit is a motor driver.

13. The apparatus of claim 11, wherein the drive circuit is a high-side, half-bridge drive circuit.

14. The apparatus of claim 1, wherein the bootstrap programming circuit optimizes its one or more outputs for worst-case high and low duty cycles of the PWM input signal.

15. The apparatus of claim 14, wherein the worst-case high and low duty cycles cover a duty cycle from 1% to 99%.

16. The apparatus of claim 1, further comprising a EEPROM to store the one or more outputs of the bootstrap programming circuit

17. Apparatus, comprising:
means to receive an indication of a frequency of a pulse-width modulated (PWM) input signal, the PWM input signal being generated for the purpose of controlling a drive circuit; and
means to, in response to the indication of the frequency of the PWM input signal, generate one or more outputs for programming one or more programmable components of a bootstrap circuit that provides a supply voltage for the drive circuit.

18. A method, comprising:
receiving an indication of a frequency of a pulse-width modulated (PWM) input signal, the PWM input signal being generated for the purpose of controlling a drive circuit; and
in response to the indication of the frequency of the PWM input signal, automatically and electronically generating one or more outputs for programming one or more programmable components of a bootstrap circuit that provides a supply voltage for the drive circuit.

19. The method of claim 18, wherein the one or more outputs comprise outputs for programming a bootstrap resistance value and a bootstrap capacitance value.

20. The method of claim 18, further comprising, receiving the PWM input signal and deriving the indication of the frequency of the PWM input signal.
